(19) United States
(12) Patent Application Publication
(10) Pub. No.: US 2024/0235328 A1
(43) Pub. Date: Jul. 11, 2024

(54) COOLING FOR ELECTRIC MOTORS

(71) Applicant: GM GLOBAL TECHNOLOGY OPERATIONS LLC, DETROIT, MI (US)

(72) Inventors: Farzad Samie, Franklin, MI (US); Peng Peng, Columbus, OH (US); Xiaofeng Yang, Troy, MI (US); Alireza Fatemi, Canton, MI (US)

(21) Appl. No.: 18/151,504

(22) Filed: Jan. 9, 2023

(51) Int. Cl. H02K 9/19; B60K 11/02

(52) U.S. Cl. CPC H02K 9/19; B60K 11/02

(57) ABSTRACT

Embodiments include a system for cooling an electric motor and a vehicle including the same. The system for cooling the electric motor includes a pump configured to circulate a conductive cooling fluid through one or more portions of the electric motor and a heat exchanger configured to receive and cool the conductive cooling fluid received from the electric motor.

### INTRODUCTION

The subject disclosure relates to electric motors. In particular, the invention relates to methods and apparatus for cooling electric motors.

Electric motors can generally be described as having a stator and a rotor. The stator is fixed in place and the rotor operates relative to the stator. In electric motors, the stator is typically a current-carrying component of an electric motor, which generates a magnetic field that interacts with the rotor. The rotor of the electric motor includes a magnetic rotor and the magnetic field generated by the stator is controlled to rotate the rotor.

In general, heat is generated by the action of the electric motor in both the rotor and the stator. The stator and rotor are cooled to prevent the electric motor (i.e., the motor) from overheating. Overheating, if not properly prevented, may cause issues including but not limited to reduced magnet flux, irreversible demagnetization of the magnet, insulation failure, excessive copper loss, etc., therefore causing lower power output, lower efficiency, and even motor malfunction.

Existing high-power-dense electric motors tend to be smaller in size and higher in speed. This allows an increased power density (i.e., kW/L) or specific power (i.e., kW/kg). Heat loss (i.e., heat dissipation) is a limiting factor in the design of a high-power-dense electric motor. The purpose of motor cooling is to prevent overheating therefore preventing failures and improving motor efficiency and power output especially in critical conditions (i.e., high current and high speed) as mentioned above.

### SUMMARY

In one exemplary embodiment cooling system for an electric motor is provided. The cooling system includes a pump configured to circulate a conductive cooling fluid through one or more portions of the electric motor and a heat exchanger configured to receive and cool the conductive cooling fluid received from the electric motor.

In addition to one or more of the features described herein, the one or more portions of the electric motor includes one or more cooling channels disposed in a stator of the electric motor.

In addition to one or more of the features described herein, the one or more cooling channels comprise a first set of channels that are interleaved with a second set of channels in an axial direction, wherein each of the first set of channels and the second set of channels have a major axis oriented in a non-radial and non-tangential direction.

In addition to one or more of the features described herein, the one or more portions of the electric motor includes one or more windings that are disposed in a stator of the electric motor.

In addition to one or more of the features described herein, a rotor of the electric motor includes one or more cooling pipes that are at least partially filled with the conductive cooling fluid.

In addition to one or more of the features described herein, a rotor of the electric motor includes one or more magnet channels that are at least partially filled with the conductive cooling fluid.

In addition to one or more of the features described herein, a stator of the electric motor includes one or more winding slots that are at least partially filled with the conductive cooling fluid.

In addition to one or more of the features described herein, the pump is a magnetohydrodynamic pump.

In another exemplary embodiment an electric motor is provided. The electric motor includes a stator and a rotor having one or more cooling pipes that are at least partially filled with a conductive cooling fluid.

In addition to one or more of the features described herein, the stator includes one or more winding slots that are at least partially filled with the conductive cooling fluid.

In addition to one or more of the features described herein, the rotor further includes one or more magnet channels that are at least partially filled with the conductive cooling fluid.

In another exemplary embodiment a vehicle is provided. The vehicle includes an electric motor and a cooling system for the electric motor. The cooling system includes a pump configured to circulate a conductive cooling fluid through one or more portions of the electric motor and a heat exchanger configured to receive and cool the conductive cooling fluid received from the electric motor.

In addition to one or more of the features described herein, the one or more portions of the electric motor includes one or more cooling channels disposed in a stator of the electric motor.

In addition to one or more of the features described herein, the one or more cooling channels comprise a first set of channels that are interleaved with a second set of channels in an axial direction, wherein each of the first set of channels and the second set of channels have a major axis oriented in a non-radial and non-tangential direction.

In addition to one or more of the features described herein, the one or more cooling channels are coated with a sealant that prevents the conductive cooling fluid from leaking.

In addition to one or more of the features described herein, the one or more portions of the electric motor includes one or more windings that are disposed in a stator of the electric motor and wherein the one or more windings are filled with the conductive cooling fluid.

In addition to one or more of the features described herein, a rotor of the electric motor includes one or more cooling pipes that are at least partially filled with the conductive cooling fluid.

In addition to one or more of the features described herein, a rotor of the electric motor includes one or more magnet channels that are at least partially filled with the conductive cooling fluid.

In addition to one or more of the features described herein, a stator of the electric motor includes one or more winding slots that are at least partially filled with the conductive cooling fluid.

In addition to one or more of the features described herein, the pump is a magnetohydrodynamic pump.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a schematic diagram of a vehicle for use in conjunction with one or more embodiments of the present disclosure;

FIG. 2A is a schematic diagram of an electric motor in accordance with one or more embodiments of the present disclosure;

FIG. 2B is a schematic diagram of another electric motor in accordance with one or more embodiments of the present disclosure;

FIG. 3A is a schematic diagram of portions of a stator of an electric motor in accordance with one or more embodiments of the present disclosure;

FIG. 3B is a schematic diagram of a cavity network of a stator of an electric motor for use in conjunction with one or more embodiments of the present disclosure;

FIG. 4A is a schematic diagram of a cooling system of a stator of an electric motor for use in conjunction with one or more embodiments of the present disclosure;

FIG. 4B is a schematic diagram of a cooling system of a stator of an electric motor for use in conjunction with one or more embodiments of the present disclosure; and

FIG. 5 is a block diagram of a cooling system of an electric motor for use in conjunction with one or more embodiments of the present disclosure.

### DETAILED DESCRIPTION

The following description is merely exemplary in nature and is not intended to limit the present disclosure, its application or uses. It should be understood that throughout the drawings, corresponding reference numerals indicate like or corresponding parts and features.

In accordance with an exemplary embodiment, cooling systems and methods for an electric motor are provided. In exemplary embodiments, the cooling systems include the use of conductive cooling fluid to enhance the cooling of the electric motor. In one embodiment, the conductive cooling fluid includes a gallium alloy, such as GaInSnZn (Gallium-Indium-Tin-Zinc), which has a thermal conductivity of approximately 35 watts per metre-kelvin (W/m·k) and an electrical conductivity of approximately 8×10⁶ Siemens per meter (S/m). In exemplary embodiments, various conductive cooling fluids can be used which have different levels of thermal conductivity and electrical conductivity.

In exemplary embodiments, the conductive cooling fluid may be disposed in various portions of the electric motor to enhance the cooling of the electric motor. In one embodiment, the conductive cooling fluid is circulated through a network of cooling channels disposed on the back iron of the stator of the electric motor. In another embodiment, the rotor of the electric motor includes one or more cooling slots that include closed pipes that are filled with a conductive cooling fluid. In a further embodiment, the winding slots in the stator of an electric motor include a space between the windings and the stator that is filled with a conductive cooling fluid. In another embodiment, the rotor of an electric motor includes a space between the magnets and the rotor that is filled with a conductive cooling fluid. In a further embodiment, the electric motor includes hollow windings that are filled with a conductive cooling fluid.

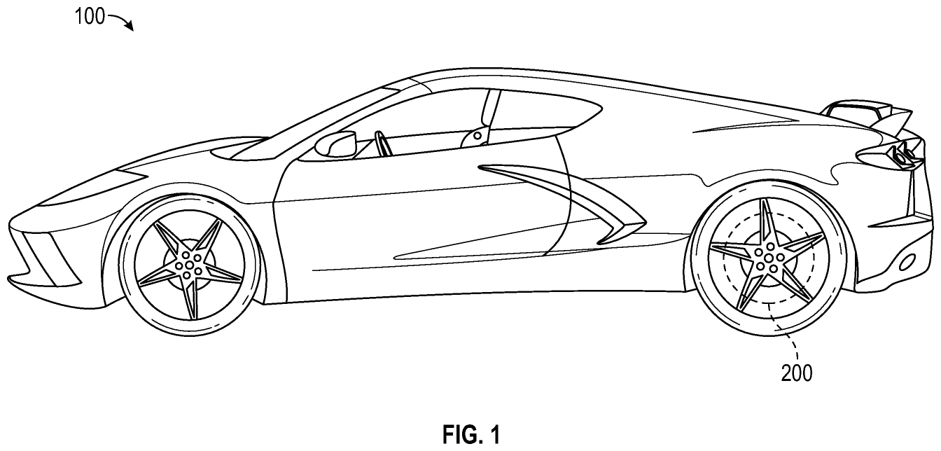

Referring now to FIG. 1, a schematic diagram of a vehicle 100 for use in conjunction with one or more embodiments of the present disclosure is shown. The vehicle 100 includes an electric motor 200. In one embodiment, the vehicle 100 is a hybrid vehicle that utilizes both an internal combustion engine and an electric motor. In another embodiment, the vehicle 100 is an electric vehicle that only utilizes electric motors.

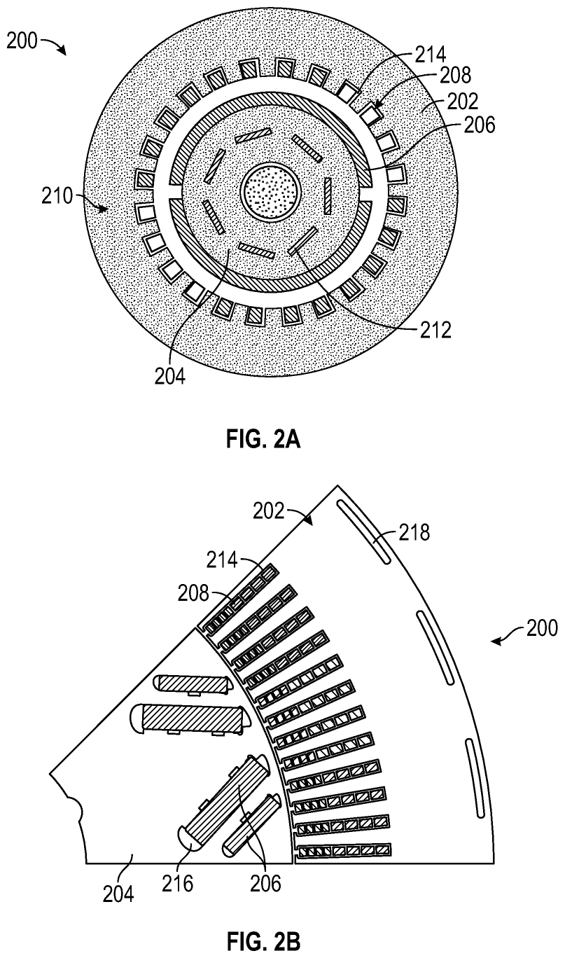

Referring now to FIG. 2A, a schematic diagram of an electric motor 200 for use in conjunction with one or more embodiments of the present disclosure is shown. As illustrated, the electric motor 200 includes a stator 202 and a rotor 204. The stator 202 includes one or more windings 208 that are configured to produce an electromagnetic field and the rotor 204 includes one or more magnets 206 that are configured to interact with the electromagnetic field produced by the windings 208. The stator 202 also includes a back-iron portion 210 that is disposed around the outer circumference of the stator 202. In exemplary embodiments, the stator 202 includes a space 214 disposed between the windings 208 and the stator 202.

In one embodiment, the rotor 204 includes one or more slots that house cooling pipes 212, which are metal structures that are at least partially filled with a conductive cooling fluid. In exemplary embodiments, the cooling pipes 212 are enclosed and during the operation of the electric motor 200 the conductive cooling fluid flows through the cooling pipes due to centrifugal force and non-uniform temperature/density. The cooling pipes 212 are disposed within a body of the rotor 204 and extend axially from a first end of the rotor 204 to a second end of the rotor. As a result, convective heat transfer from the rotor 204 occurs along the axial direction of the electric motor 200. The convective heat transfer lowers the maximum temperature of the rotor 204 and facilitates a more even temperature distribution in the rotor 204 along the axial direction of the electric motor.

Referring now to FIG. 2B, a schematic diagram of an electric motor 200 for use in conjunction with one or more embodiments of the present disclosure is shown. As shown, the stator 202 includes a plurality of cooling channels 218 that are disposed around the outer circumference of the stator 202. In exemplary embodiments, a conductive cooling fluid is circulated through the plurality of cooling channels 218 during the operation of the electric motor 200. In exemplary embodiments, traditional electric pumps or magnetohydrodynamic pumps can be used to pump conductive cooling fluid through the cooling channels 218. The conductive cooling fluid absorbs heat from the stator 202 and therefore limits the temperature of the stator 202. In exemplary embodiments, the cooling channels 218 are coated with a sealant that prevents the conductive fluid from leaking.

In exemplary embodiments, the stator 202 includes a plurality of s slots 214 that are configured to hold the windings 208. In exemplary embodiments, the space between the windings 208 and the stator 202 is filled or partially filled with a conductive cooling fluid. In exemplary embodiments, the windings are covered with an insulating material to prevent potential electrical conduction between the windings 208 and the stator 202. In exemplary embodiments, filling the space adjacent to the windings 208 with a conductive cooling fluid improves the heat transfer from the windings 208 to the stator 202.

In exemplary embodiments, the rotor 204 includes a plurality of magnet channels 216 that are configured to hold magnets 206. In exemplary embodiments, the space between the magnets 206 and the rotor 204 is filled with a conductive cooling fluid. In general, the magnets 206 of an electric motor are susceptible to high temperatures and filling the space adjacent to the magnets 206 with a conductive cooling fluid improves the heat transfer from the magnet 206 to the rotor 204. In exemplary embodiments, the conductive cooling fluid flows through the space around the magnets due to centrifugal force and non-uniform temperature/density. As a result, convective heat transfer from the rotor 204 occurs along the axial direction of the electric motor 200. The convective heat transfer lowers the maximum temperature of the rotor 204 and facilitates a more even temperature distribution in the rotor 204 along the axial direction of the electric motor.

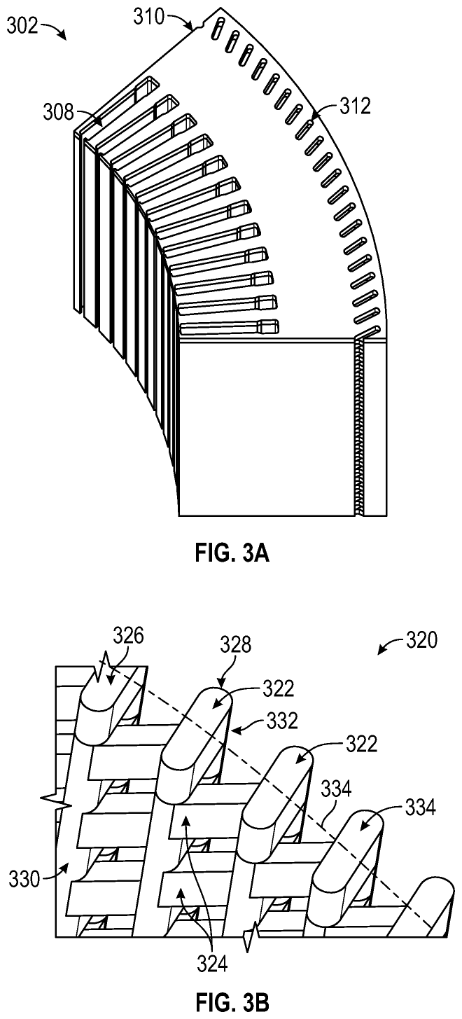

Referring now to FIG. 3A, a schematic diagram of a portion of a stator 302 of an electric motor in accordance with one or more embodiments of the present disclosure is shown. As illustrated, the stator 302 includes a plurality of slots 308 that are configured to hold windings (not shown). The stator 302 also includes a back-iron portion 310 that includes cooling channels 312. In exemplary embodiments, the cooling channels 312 can include two sets of interleaved apertures that are each disposed in a non-radial and non-tangential direction. In exemplary embodiments, a conductive cooling fluid is configured to flow through the cooling channels 312 to remove heat from the stator 302.

Referring now to FIGS. 3B a schematic diagram of a cavity network 320 of a stator of an electric motor for use in accordance with one or more embodiments of the present disclosure is shown. In exemplary embodiments, a conductive cooling fluid is configured to flow through the cavity network 320 during operation of the electric motor. As illustrated, the cavity network 320 includes a first set of channels 322 that are interleaved with a second set of channels 324 in an axial direction. The first set of channels 322 includes a plurality of elongated channels that each extend from a first end 326 to a second end 328. The second set of channels 324 includes a plurality of elongated channels that each extend from a first end 330 to a second end 332.

In exemplary embodiments, a major axis 334 of each of the first set of channels 322 and the second set of channels 324 are disposed in a non-radial and non-tangential direction. For example, in one embodiment, the major axis of each of the first set of channels 322 is offset from a radial direction by approximately thirty degrees in a first direction and the major axis of each of the second set of channels 322 is offset from a radial direction by approximately thirty degrees in a direction opposite of the first direction.

In exemplary embodiments, the first end 326 of each of the first set of channels 322 is configured to overlap with the first end 330 of the second set of channels 324 that are disposed above and below the first set of channels 322. Likewise, the second end 328 of each of the first set of channels 322 is configured to overlap with the second end 332 of the second set of channels 324 that are disposed above and below the first set of channels 322. Accordingly, the first set of channels 322 and the second set of channels 324 of the cooling channels 300 are in fluid communication with one another.

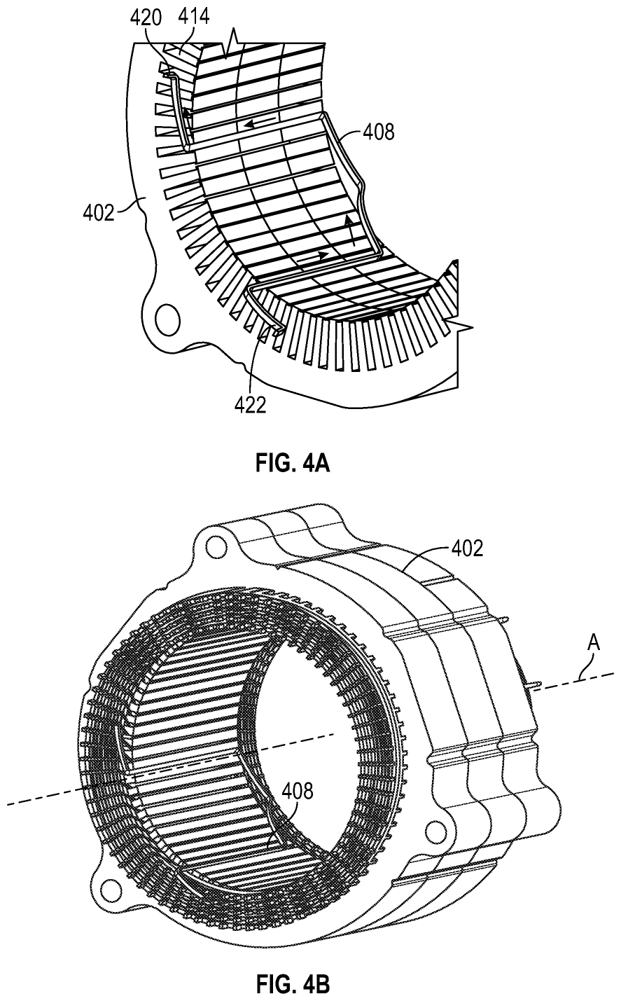

Referring now to FIGS. 4A and 4B, schematic diagrams of a cooling system of a stator 402 of an electric motor for use in conjunction with one or more embodiments of the present disclosure are shown. As illustrated, the stator 402 includes a plurality of slots 414. In exemplary embodiments, each slot 414 includes one or more windings 408. In exemplary embodiments, each winding 408 includes a hollow structure that is made of a conducive material, such as copper.

In one embodiment, the windings 408 have a first end 420 and second end 422, the windings 408 are filled with a conductive cooling fluid, and the first end 420 and the second end 422 are closed (i.e., the conductive cooling fluid is not able to escape the winding 408). The conductive cooling fluid is configured to enhance the heat transfer along the length of the winding 408. In an exemplary embodiment, the conductive cooling fluid flows through the windings 408 due, at least in part, to the non-uniform temperature/density of the conductive cooling fluid within the winding 408. As a result, convective heat transfer of the stator 402 occurs along the axial direction “A” of the electric motor. The convective heat transfer lowers the maximum temperature of the stator 402 and facilitates a more even temperature distribution of the stator 402 along the axial direction of the electric motor.

In another embodiment, the windings 408 have an open first end 420 and an open second end 422 and the windings 408 are connected to a cooling system that is configured to circulate a conductive cooling fluid through the windings to cool the stator 402. In exemplary embodiments, one or more fluid input manifolds are configured to receive conductive cooling fluid and provide the conductive cooling fluid to the first end 420 of the windings 408. The fluid input manifolds may include one or more insulators that are configured to electrically isolate the conductive cooling fluid that is provided to different electrical phases of windings 408. Likewise, one or more fluid output manifolds are configured to receive the conductive cooling fluid from the second end 422 of the windings 408 and provide the conductive cooling fluid to a heat exchanger that cools the conductive cooling fluid. In exemplary embodiments, the heat exchanger includes internal electrical insulation avoiding electrical short between coolant flowing through different phases. The fluid output manifolds may include one or more insulators that are configured to electrically isolate the conductive cooling fluid that is received from windings 408 that have different electrical phases.

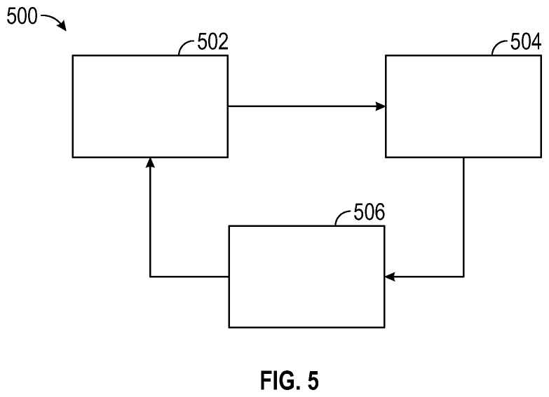

FIG. 5 is a block diagram of a cooling system 500 for cooling an electric motor in accordance with one or more embodiments of the present disclosure. In exemplary embodiments, the cooling system 500 includes a pump 502 that is configured to circulate a conductive cooling fluid through one or more portions of the electric motor 504 and through a heat exchanger 506. In various embodiments, the pump 502 is one of a traditional electric pump or magnetohydrodynamic pump, based on whether the conductive cooling fluid has an electrical conductivity greater than a threshold value.

In exemplary embodiments, the one or more portions of the electric motor 504 include one or more of a plurality of cooling channels 218 (shown in FIG. 2B), a plurality of cooling channels 312 (shown in FIG. 3A), a cavity network 320 (shown in FIG. 3B), and one or more windings 408 (shown in FIGS. 4A and 4B). In one embodiment, where the pump 502 is configured to circulate conductive cooling fluid that is electrically conductive through the one or more windings of the electric motor, the pump 502 and the heat exchanger 506 include insulators that are configured to prevent conductive cooling fluid that is in fluid communication with a first phase of the electric motor from contacting conductive cooling fluid that is in fluid communication with another phase of the electric motor. In one embodiment, separate pumps 502 and heat exchangers 506 can be configured to supply conductive cooling fluid to windings having different phases.

In exemplary embodiments, utilizing a conductive cooling fluid to cool one or more portions of an electric motor enhances the operation of the electric motor by more efficiently dissipating the heat generated by the electric motor. As a result, electric motors cooled with a conductive cooling fluid can operate at higher speeds and for longer durations that traditionally cooled electric motors.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A cooling system for an electric motor comprising:
a pump configured to circulate a conductive cooling fluid through one or more portions of the electric motor; and
a heat exchanger configured to receive and cool the conductive cooling fluid received from the electric motor.

2. The cooling system of claim 1, wherein the one or more portions of the electric motor includes one or more cooling channels disposed in a stator of the electric motor.

3. The cooling system of claim 2, wherein the one or more cooling channels comprise a first set of channels that are interleaved with a second set of channels in an axial direction, wherein each of the first set of channels and the second set of channels have a major axis oriented in a non-radial and non-tangential direction.

4. The cooling system of claim 1, wherein the one or more portions of the electric motor includes one or more windings that are disposed in a stator of the electric motor.

5. The cooling system of claim 1, wherein a rotor of the electric motor includes one or more cooling pipes that are at least partially filled with the conductive cooling fluid.

6. The cooling system of claim 1, wherein a rotor of the electric motor includes one or more magnet channels that are at least partially filled with the conductive cooling fluid.

7. The cooling system of claim 1, wherein a stator of the electric motor includes one or more winding slots that are at least partially filled with the conductive cooling fluid.

8. The cooling system of claim 1, wherein the pump is a magnetohydrodynamic pump.

9. An electric motor comprising:
a stator; and
a rotor having one or more cooling pipes that are at least partially filled with a conductive cooling fluid.

10. The electric motor of claim 9, wherein the stator includes one or more winding slots that are at least partially filled with the conductive cooling fluid.

11. The electric motor of claim 9, wherein the rotor further includes one or more magnet channels that are at least partially filled with the conductive cooling fluid.

12. A vehicle comprising:
an electric motor; and
a cooling system for the electric motor, the cooling system comprising:
a pump configured to circulate a conductive cooling fluid through one or more portions of the electric motor; and
a heat exchanger configured to receive and cool the conductive cooling fluid received from the electric motor.

13. The vehicle of claim 12, wherein the one or more portions of the electric motor includes one or more cooling channels disposed in a stator of the electric motor.

14. The vehicle of claim 13, wherein the one or more cooling channels comprise a first set of channels that are interleaved with a second set of channels in an axial direction, wherein each of the first set of channels and the second set of channels have a major axis oriented in a non-radial and non-tangential direction.

15. The vehicle of claim 13, wherein the one or more cooling channels are coated with a sealant that prevents the conductive cooling fluid from leaking.

16. The vehicle of claim 12, wherein the one or more portions of the electric motor includes one or more windings that are disposed in a stator of the electric motor and wherein the one or more windings are filled with the conductive cooling fluid.

17. The vehicle of claim 12, wherein a rotor of the electric motor includes one or more cooling pipes that are at least partially filled with the conductive cooling fluid.

18. The vehicle of claim 12, wherein a rotor of the electric motor includes one or more magnet channels that are at least partially filled with the conductive cooling fluid.

19. The vehicle of claim 12, wherein a stator of the electric motor includes one or more winding slots that are at least partially filled with the conductive cooling fluid.

20. The vehicle of claim 12, wherein the pump is a magnetohydrodynamic pump.
